(19) United States
(12) Patent Application Publication
(10) Pub. No.: US 2002/0160896 A1
(43) Pub. Date: Oct. 31, 2002

(54) Roll mounted t-shirt style produce bag method for making and dispenser for same

(76) Inventors: Ron C. Yeh, Morganville, NJ (US); Ben Tseng, East Brunswick, NJ (US); James A. Jacobsen, Towaco, NJ (US)

Correspondence Address: David A. Belasco, BEEHLER & PAVITT, Suite 330, 100 Corporate Pointe, Culver City, CA, 90230, US

(21) Appl. No.: 09/843,347

(22) Filed: Apr. 27, 2001

(51) Int. Cl. B65D 33/10; B65D 85/672; B31B 1/36

(52) U.S. Cl. 493/180; 206/390; 221/283; 383/8

(57) ABSTRACT

A roll mounted T-shirt bag, method for making and dispenser for same are described. The bag is designed for fresh produce and includes front and rear panels, first and second side gussets, a bottom seam, a top seam and a U-shaped cutout forming an openable bag mouth and a pair of carrying handles. The bags are joined above and below the upper and lower seams at first and second perforation lines. The bags are wound onto a cylindrical core to form a compact roll. In a variant of the invention, the bags are folded inwardly from the side edges prior to rolling onto the core to form a more compact roll. A method is described for forming the bags from an extruded tube of plastic film material. Dispensers are described that are designed to hold the roll mounted bags in both folded and unfolded form. The dispensers include a separating tongue designed to engage the U-shaped cutout. Variants of the invention also include a breaker member designed to facilitate separating the bags from each other at the perforation lines and lateral guide members designed to control lateral movement of the bag roll in the dispenser.

### FIELD OF INVENTION

The invention pertains to plastic produce bags. More particularly, the invention relates to expandable plastic film gusseted bags having integral carrying handles designed for roll dispensing.

### BACKGROUND OF THE INVENTION

Roll mounted produce bags are commonly found in most modern grocery stores. These bags are designed for customers to use when purchasing fresh produce. The bags currently available have several problems. First, the bags tend to cling together and are difficult to separate from the roll. Second, it is difficult to tell the open end of the bag from the closed end of the bag. Third, the bags are difficult to open as the sides tend to cling together. Fourth, the bags do not provide carrying handles. A roll-mounted produce bag that can be easily opened and that provides carrying handles would save time and effort for produce purchasers.

Various designs have been developed for roll mounted bags and dispensers for such bags, incorporating a number of different technologies. U.S. Pat. No. 5,752,666 issued to Simhaee discloses a roll of plastic bags wound on a core in a star-sealed configuration for use with a dispenser having opposing tracks in which the roll is supported. The dispenser has a separating tongue for enabling individual bags to be separated from the roll. Separation lines are provided between adjacent bags, a slot in each separation line being engageable by the tongue within the dispenser so that individual bags may be dispensed from the roll one at a time.

U.S. Pat. No. 5,556,019 issued to Morris, describes a bag separator and dispenser for use with bags wound on a core and separated by perforation lines at each end of the bags. The perforation lines include a slot that is collinear with the perforations and is used to engage a separator projection. The projection enters the slot as the bags are pulled from the roll. The dispenser includes two braking devices to control the removal of bags from the roll, a braking bar underneath the roll of bags and a pair of fingers that are attached to the channel for the core and are designed to engage the core as the number of bags on the roll decreases.

U.S. Pat. No. 5,135,134, issued to Dancy discloses a deformable plastic bag dispenser for a continuous roll of plastic bags. The dispenser is cylindrical in shape and includes a longitudinal slot for dispensing the bags. Adjacent bags on the roll are attached by a perforated tear line. The dispenser is deformable to allow the operator to grip the roll by squeezing the dispenser, preventing further rotation of the roll, and allowing a bag to be removed from the roll.

U.S. Pat. No. 4,793,539 issued to Haenni et al. describes a through-counter dispensing system for plastic bags. A dispensing nozzle is fitted to a hole in a countertop. The bags are wound on rolls mounted to racks beneath the counter. The nozzle includes frictional elements in the form of a zig-zag slot designed to allow a first bag to be torn from a subsequent bag as the first bag is pulled through the slot. An enlarged loading opening is provided at one side of the slot to facilitate loading of the first bag into the nozzle for dispensing.

While other variations exist, the above-described designs for roll mounted bags and dispensers are typical of those encountered in the prior art.

It is an objective of the present invention to provide a T-shirt type produce bag that can be mounted on a continuous roll. It is a further objective to provide such a bag that can be easily and inexpensively manufactured in a variety of sizes. It is a still further objective of the invention to provide a bag that can be easily opened. It is yet a further objective to provide for bags that a user can easily identify as to the open end. In is another objective of the invention to provide a dispenser that can conveniently store the bags and that can separate the bags upon dispensing. Finally, it is an objective of the invention that the dispenser be capable of opening the bags for the user.

While some of the objectives of the present invention are disclosed in the prior art, none of the inventions found include all of the requirements identified. The present invention addresses many of the deficiencies of prior art roll mounted bags and dispensers and satisfies all of the objectives described above.

### SUMMARY OF THE INVENTION

A roll mounted plastic produce bag providing the desired features may be constructed from the following components. A front panel has first and second parallel linear side edges, a top edge and a bottom edge. A rear panel has first and second parallel linear side edges, a top edge and a bottom edge. Two front gusset panels of a first predetermined dimension are provided. Each front gusset panel has a top edge, a bottom edge, first and second parallel side edges. The front gusset panels are connected at the first side edge to one of the linear side edges of the front panel and extend from the top edge to the bottom edge of the front panel.

Two rear gusset panels of the first predetermined dimension are provided. Each rear gusset panel has a top edge, a bottom edge, first and second parallel side edges. The rear gusset panels are connected at the first side edge to one of the linear side edges of the rear panel and extend from the top edge to the bottom edge of the rear panel. Each front gusset panel is also connected to a respective one of the rear gusset panels at the second side edge. Each of the front and rear gusset panels is folded inwardly relative to the front and the rear panel.

The top edges of the front panel, the rear panel, the front gusset panels and the rear gusset panels terminate in a first perforation line. The first perforation line is perpendicular to the linear side edges of the front and rear panels. An upper seam connects the front panel, the rear panel, the front gusset panels and the rear gusset panels at a level spaced downwardly from and parallel to the first perforation line. The bottom edges of the front panel, the rear panel, the front gusset panels and the rear gusset panels terminate in a second perforation line. The second perforation line is perpendicular to the linear side edges of the front and rear panels. A lower seam connects the front panel, the rear panel, the front gusset panels and the rear gusset panels at a level spaced upwardly from and parallel to the second perforation line.

A U-shaped cutout is located in an upper portion of the bag. The U-shaped cutout begins at a first point along the first perforation line. The point is spaced inwardly from the first linear side edge and extends to a second point along the first perforation line. The second point is spaced inwardly from the second linear side edge. The cutout extends downwardly toward the lower seam, forming an open mouth and a pair of bag handles. The second perforation line attaches the bag to a subsequent bag. The bags are rolled from their upper seams toward their lower seams onto a cylindrical core to form a compact roll from which the bags are dispensed.

In a variant of the invention, the bag is folded inwardly from the first and second linear side edges for a third predetermined dimension prior to rolling the bags onto a cylindrical core, thereby providing a more compact roll of bags.

In a further variant of the invention, the method for forming a roll mounted plastic produce bag includes the following steps: Extruding a continuous tube of plastic film material. The tube has first and second parallel sides. Folding the tube inwardly at the first and second side for a first predetermined distance to form a pair of gussets. Flattening the tube to form a front panel and a rear panel. Each of the panels has a first linear side edge and a second linear side edge. Perforating the tube perpendicular to the first and second linear side edges to form a first perforation line. Sealing the tube at a level spaced downwardly from and parallel to the first perforation line to form an upper seam. Sealing the tube at a level spaced downwardly from and parallel to the upper seam to form a lower seam.

Perforating the tube at a level spaced downwardly from and parallel to the lower seam to form a second perforation line. Cutting a U-shaped cutout in an upper portion of the bag. The U-shaped cutout begins at a first point along the first perforation line spaced inwardly from the first linear side edge. The U-shaped cutout extends to a second point along the first perforation line spaced inwardly from the second linear side edge. The cutout extends downwardly toward the lower seam, forming an openable mouth and a pair of bag handles. Rolling the bags joined at the perforation lines onto a cylindrical core to form a compact roll.

In yet a further variant of the invention, the method for forming a roll mounted plastic produce bag includes the following additional step: Folding the bag inwardly from the first and second linear side edges for a third predetermined dimension prior to rolling the bags onto a cylindrical core, thereby providing a more compact roll of bags.

In still another variant, a dispenser for roll mounted plastic produce bags includes a backing plate. The backing plate has a top edge, a bottom edge, first and second side edges, a front surface and a back surface. First and second spindles are provided. Each of the spindles have a side member and a mounting member. The side members have a first end and a second end and are hingedly mounted at their first ends to the backing plate. The side members are mounted parallel to each other. The mounting members have a first end and a second end and are fixedly attached at their first ends to the second ends of the side members.

A separating tongue is provided. The tongue has a first end and a second end and is fixedly mounted at its first end to the front surface of the backing plate. The second end of the tongue extends outwardly from the backing plate. When a roll of plastic produce bags is A mounted between the spindles with mounting members supporting a cylindrical core of the roll, the roll will be free to rotate. The separating tongue will extend upwardly through the U-shaped cutout in a bag. The tongue serves to restrict movement of a subsequent bag when a bag is pulled from the roll by bearing against the lower seam of the subsequent bag, thereby permitting the bag to be torn from the roll.

In another variant of the invention, the dispenser is sized and shaped to accommodate produce bags for which the bag is folded inwardly from the first and second linear side edges for a third predetermined dimension prior to rolling.

In still another variant, a dispenser for roll mounted plastic produce bags includes first and second core supporting elements. The core supporting elements have parallel, upwardly angled slots. The slots are sized, shaped and located to slidably constrain first and second ends of a cylindrical produce bag core on which the bags are wound in a roll. The angled slots permit the bag core to slide downwardly within the slots as the number of bags wound onto the core diminishes. A separating tongue is provided. The separating tongue is centrally located between the angled slots, and is sized and shaped to locate the U-shaped cutout in the upper portion of the bags as bags are pulled from the roll.

A breaker member is provided. The breaker member is centrally located between and below the angled slots. The breaker member is sized and shaped to engage the U-shaped cutout in the upper portion of the bags as bags are pulled from the roll and provides a means to constrain the removal of bags from the roll so that the perforation line joining a bag to a subsequent bag will be torn as the bag is pulled from the roll. Means are provided for securing the dispenser to either of a vertical surface and a horizontal surface.

In still another variant, the dispenser is sized and shaped to accommodate produce bags for which the bag is folded inwardly from the first and second linear side edges for a third predetermined dimension prior to rolling.

In yet a further variant of the invention, the dispenser further includes first and second lateral guide members. The lateral guide members are parallel to one another and located below the angled slots and serve to control lateral movement of bag roll so as to direct the U-shaped cutout in the upper portion of the bags to the separating tongue.

In still a further variant, the dispenser is sized and shaped to accommodate produce bags for which the bag is folded inwardly from the first and second linear side edges for a third predetermined dimension prior to rolling.

In another variant, the dispenser is mounted at an angle to the horizontal of between zero and eighty-five degrees. In a final variant, the dispenser that is sized and shaped to accommodate produce bags for which the bag is folded inwardly from the first and second linear side edges for a third predetermined dimension prior to rolling is mounted at an angle to the horizontal of between zero and eighty-five degrees.

### DESCRIPTION OF THE DRAWINGS

FIG. 1 is a perspective view of the preferred embodiment of the T-shirt style bag of the present invention illustrating a pair of side gussets, upper and lower seams and an openable mouth;

FIG. 1A is a perspective view of the FIG. 1 bag folded inwardly from the parallel side edges;

FIG. 2 is a perspective view of a plurality of the FIG. 1 embodiment bags rolled onto a cylindrical core suitable for a first embodiment of a dispenser;

FIG. 2A is a perspective view of a plurality of the FIG. 1 bags folded inwardly from the parallel side edges and rolled onto a cylindrical core suitable for a first embodiment of a dispenser;

FIG. 3 is a perspective view of a plurality of the FIG. 1 embodiment bags rolled onto a cylindrical core suitable for a second embodiment of a dispenser;

FIG. 3A is a perspective view of a plurality of the FIG. 1 bags folded inwardly from the parallel side edges and rolled onto a cylindrical core suitable for a second embodiment of a dispenser;

FIG. 4 is a perspective view illustrating the method of forming the FIG. 1 embodiment bags;

FIG. 4A is a perspective view illustrating the method of forming the FIG. 1A embodiment bags from the FIG. 1 bags;

FIG. 5 is a cross sectional view of the FIG. 1A bags taken along the line 5-5;

FIG. 6 is a cross-sectional view of the flattened tube illustrated in FIG. 4 taken along the line 6-6;

FIG. 6A is a cross-sectional view of the flattened, gusseted tube forming the FIG. 1 bags illustrated in FIG. 4 taken along the line 6A-6A;

FIG. 7 is a perspective view of a dispenser suitable for the FIG. 1A rolled bags with a bag roll installed;

FIG. 8 is a perspective view of a dispenser suitable for the FIG. 1 rolled bags with a bag roll installed;

FIG. 9 is a perspective view of the FIG. 7 dispenser further illustrating a separating tongue;

FIG. 10 is a perspective view of a dispenser suitable for FIG. 1A rolled bags including lateral side supports;

FIG. 11 is a perspective view of a dispenser suitable for FIG. 1A rolled bags with a bag roll installed.

FIG. 12 is a perspective view of a dispenser suitable for FIG. 1 rolled bags with a bag roll installed and the dispenser mounted horizontally; and

FIG. 13 is a perspective view of a dispenser suitable for FIG. 1A rolled bags with a bag roll installed and the dispenser mounted at eighty-five degrees to the horizontal.

### DETAILED DESCRIPTION OF THE PREFERRED EMBODIMENT

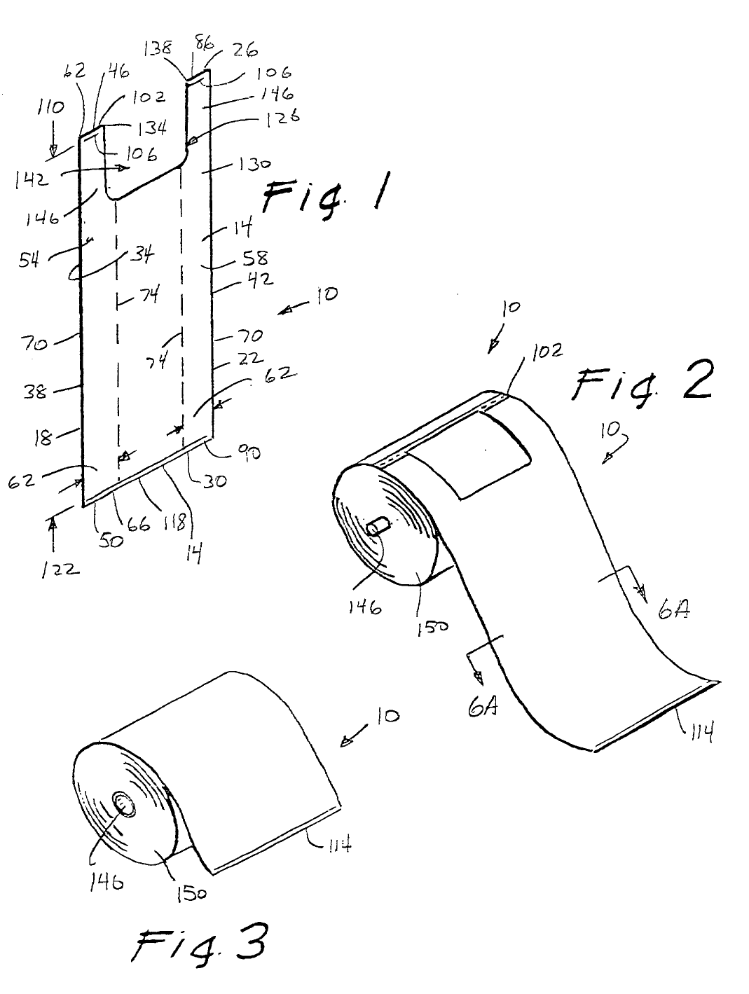

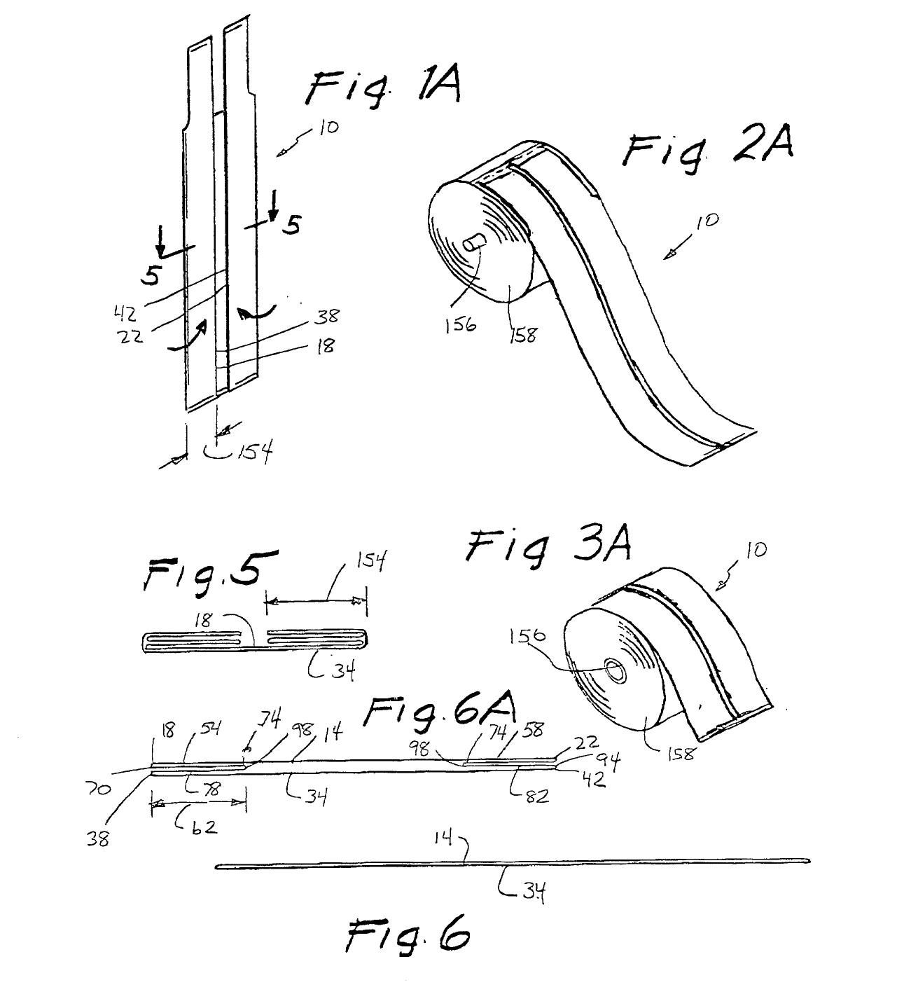

FIGS. 1, 2, 3 and 6A illustrate a roll mounted plastic produce bag 10 providing the desired features that may be constructed from the following components. A front panel 14 has first 18 and second 22 parallel linear side edges, a top edge 26 and a bottom edge 30. A rear panel 34 has first 38 and second 42 parallel linear side edges, a top edge 46 and a bottom edge 50. Two front gusset panels 54, 58 of a first predetermined dimension 62 are provided. Each front gusset panel 54, 58 has a top edge 62, a bottom edge 66, first 70 and second 74 parallel side edges. The front gusset panels 54, 58 are connected at the first side edge 70 to one of the linear side edges 18, 22 of the front panel 14 and extend from the top edge 26 to the bottom edge 30 of the front panel.

Two rear gusset panels 78, 82 of the first predetermined dimension 62 are provided. Each rear gusset panel 78, 82 has a top edge 86, a bottom edge 90, first 94 and second 98 parallel side edges. The rear gusset panels 78, 82 are connected at the first side edge 94 to one of the linear side edges 38, 42 of the rear panel 34 and extend from the top edge 46 to the bottom edge 50 of the rear panel 34. Each front gusset panel 54, 58 is also connected to a respective one of the rear gusset panels 78, 82 at the second side edge 98. Each of the front 54, 58 and rear gusset panels 78, 82 is folded inwardly relative to the front 14 and the rear panel 34.

The top edges 26, 46, 62, 86 of the front panel 14, the rear panel 34, the front gusset panels 54, 58 and the rear gusset panels 78, 82 terminate in a first perforation line 102. The first perforation line 102 is perpendicular to the linear side edges 18, 22, 38, 42 of the front 14 and rear 34 panels. An upper seam 106 connects the front panel 14, the rear panel 34, the front gusset panels 54, 58 and the rear gusset panels 78, 82 at a level 110 spaced downwardly from and parallel to the first perforation line 102. The bottom edges 30, 50, 66, 90 of the front panel 14, the rear panel 34, the front gusset panels 54, 58 and the rear gusset panels 78, 82 terminate in a second perforation line 114. The second perforation line 114 is perpendicular to the linear side edges 18, 22, 38, 42 of the front 14 and rear 34 panels. A lower seam 118 connects the front panel 14, the rear panel 34, the front gusset panels 54, 58 and the rear gusset panels 78, 82 at a level 122 spaced upwardly from and parallel to the second perforation line 114.

A U-shaped cutout 126 is located in an upper portion 130 of the bag 10. The U-shaped cutout 126 begins at a first point 134 along the first perforation line 102. The first point 134 is spaced inwardly from the first linear side edge 18, 38 and extends to a second point 138 along the first perforation line 102. The second point 138 is spaced inwardly from the second linear side edge 22, 42. The cutout 126 extends downwardly toward the lower seam 118, forming an open mouth 142 and a pair of bag handles 146. The second perforation line 114 attaches the bag 10 to a subsequent bag 10. The bags 10 are rolled from their upper seams 106 toward their lower seams 118 onto a cylindrical core 146 to form a compact roll 150 from which the bags 10 are dispensed.

In a variant of the invention, as illustrated in FIGS. 1A, 2A, 3A and 5, the bag 10 is folded inwardly from the first 18, 38 and second 22, 42 linear side edges for a third predetermined dimension 154 prior to rolling the bags 10 onto a cylindrical core 156, thereby providing a more compact roll 158 of bags 10.

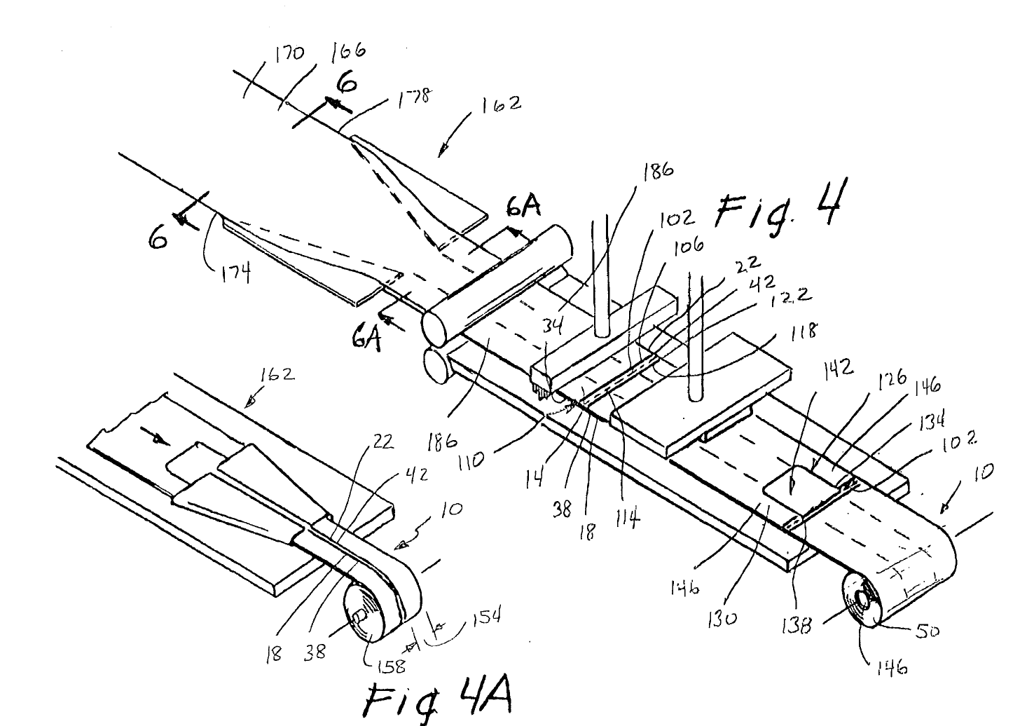

In a further variant of the invention, as illustrated in FIGS. 4, 6 and 6A, the method 162 for forming a roll mounted plastic produce bag 10 includes the following steps: Extruding a continuous tube 166 of plastic film material 170. The tube 166 has first 174 and second 178 parallel sides. Folding the tube 166 inwardly at the first 174 and second 178 side for a first predetermined distance 182 to form a pair of gussets 186. Flattening the tube 166 to form a front panel 14 and a rear panel 34. Each of the panels 14, 34 has a first linear side edge 18, 38 and a second linear side edge 22, 42. Perforating the tube 166 perpendicular to the first 18, 38 and second 22, 42 linear side edges to form a first perforation line 102. Sealing the tube 166 at a level 110 spaced downwardly from and parallel to the first perforation line 102 to form an upper seam 106. Sealing the tube 166 at a level 122 spaced downwardly from and parallel to the upper seam 106 to form a lower seam 118.

Perforating the tube 166 at a level 190 spaced downwardly from and parallel to the lower seam 118 to form a second perforation line 114. Cutting a U-shaped cutout 126 in an upper portion 130 of the bag 10. The U-shaped cutout 126 begins at a first point 134 along the first perforation line 102 spaced inwardly from the first linear side edge 18, 38. The U-shaped cutout 126 extends to a second point 138 along the first perforation line 102 spaced inwardly from the second linear side edge 22, 42. The cutout 126 extends downwardly toward the lower seam 118, forming an openable mouth 142 and a pair of bag handles 146. Rolling the bags 10 joined at the perforation lines 102, 114 onto a cylindrical core 146 to form a compact roll 150.

In yet a further variant of the invention, as illustrated in FIGS. 1A, 2A, 3A, 4A and 5, the method 162 for forming a roll mounted plastic produce bag 10 includes the following additional step: Folding the bag 10 inwardly from the first 18, 38 and second 22, 42 linear side edges for a third predetermined dimension 154 prior to rolling the bags 10 onto a cylindrical core 156, thereby providing a more compact roll 158 of bags 10.

In still another variant, as illustrated in FIG. 8, a dispenser 194 for roll mounted plastic produce bags 10 includes a backing plate 198. The backing plate 198 has a top edge 202, a bottom edge 206, first 210 and second 214 side edges, a front surface 218 and a back surface 222. First 226 and second 230 spindles are provided. Each of the spindles 226, 230 has a side member 234 and a mounting member 238. The side members 234 have a first end 242 and a second end 246 and are hingedly mounted at their first ends 242 to the backing plate 198. The side members 234 are mounted parallel to each other. The mounting members 238 have a first end 250 and a second end 254 and are fixedly attached at their first ends 250 to the second ends 246 of the side members 234.

A separating tongue 258 is provided. The tongue 258 has a first end 262 and a second end 266 and is fixedly mounted at its first end 262 to the front surface 218 of the backing plate 198. The second end 266 of the tongue 258 extends outwardly from the backing plate 198. When a roll 150 of plastic produce bags 10 is mounted between the spindles 226, 230 with mounting members 238 supporting a cylindrical core 146 of the roll 150, the roll 150 will be free to rotate. The separating tongue 258 will extend upwardly through the U-shaped cutout 126 in a bag 10. The tongue 258 serves to restrict movement of a subsequent bag 10 when a bag 10 is pulled from the roll 150 by bearing against the lower seam 118 of the subsequent bag 10, thereby permitting the bag 10 to be torn from the roll 150.

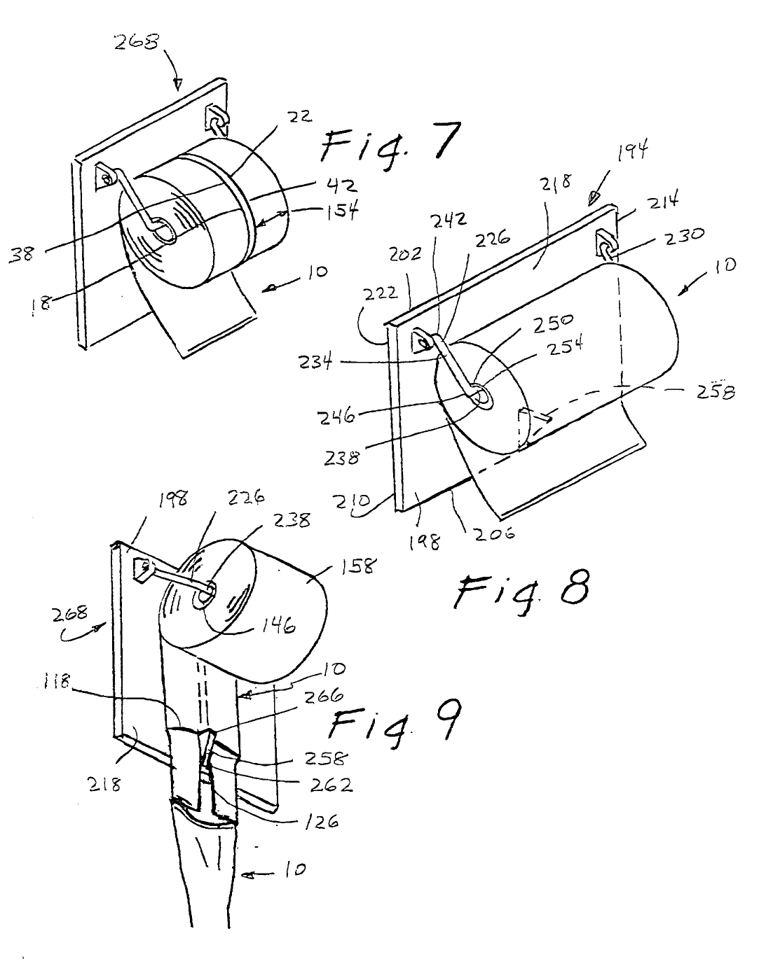

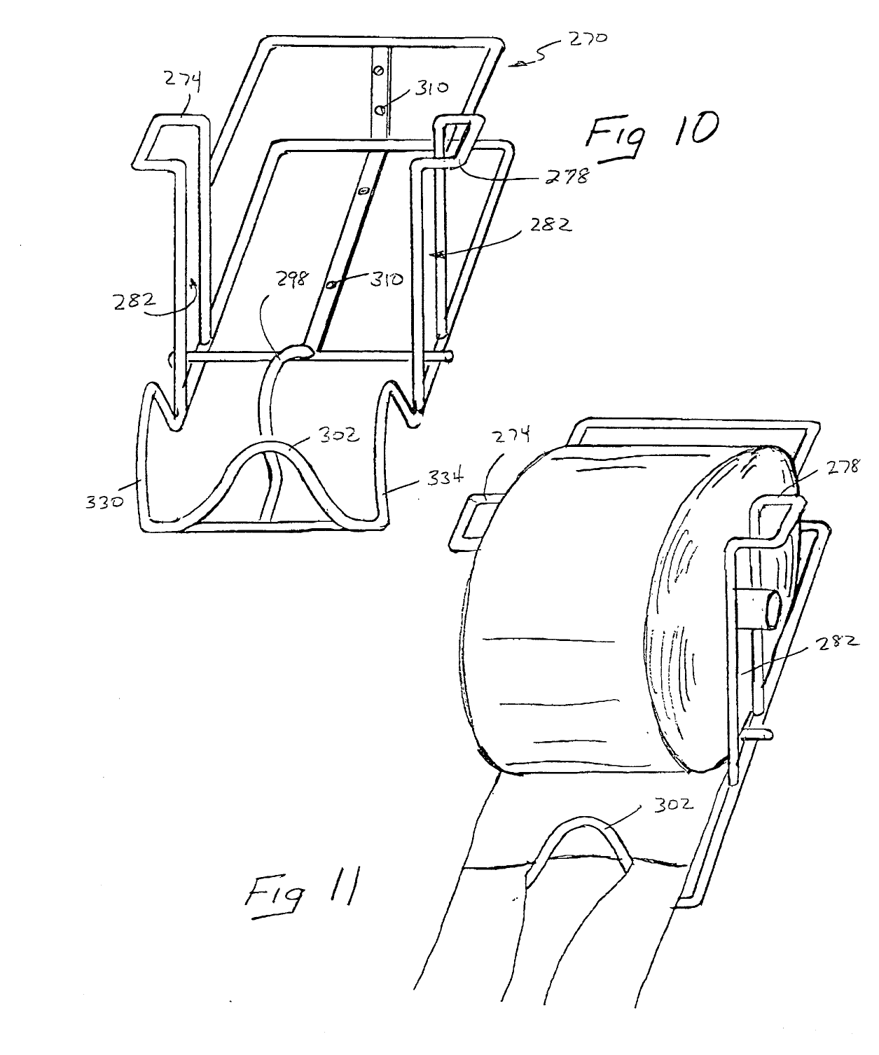

In another variant of the invention, as illustrated in FIGS. 7 and 9, the dispenser 268 is sized and shaped to accommodate produce bags 10 for which the bag 10 is folded inwardly from the first 18, 38 and second 22, 42 linear side edges for a third predetermined dimension 154 prior to rolling.

In still another variant, as illustrated in FIGS. 10 and 11, a dispenser 270 for roll mounted plastic produce bags 10 includes first 274 and second 278 core supporting elements. The core supporting elements 274, 278 have parallel, upwardly angled slots 282. The slots 282 are sized, shaped and located to slidably constrain first 286 and second (not shown) ends of a cylindrical produce bag core 294 on which the bags 10 are wound in a roll 158. The angled slots 282 permit the bag core 294 to slide downwardly within the slots 282 as the number of bags 10 wound onto the core 294 diminishes. A separating tongue 298 is provided. The separating tongue 298 is centrally located between the angled slots 282, and is sized and shaped to locate the U-shaped cutout 126 in the upper portion 130 of the bags 10 as bags 10 are pulled from the roll 158.

A breaker member 302 is provided. The breaker member 302 is centrally located between and below the angled slots 282. The breaker member 302 is sized and shaped to engage the U-shaped cutout 126 in the upper portion 130 of the bags 10 as bags 10 are pulled from the roll 158 and provides a means to constrain the removal of bags 10 from the roll 158 so that the perforations 102, 114 joining a bag 10 to a subsequent bag 10 will be torn as the bag 10 is pulled from the roll 158. Means 310 are provided for securing the dispenser 270 to either of a vertical surface (not shown) and a horizontal surface (not shown).

In yet a further variant of the invention, also illustrated in FIGS. 10 and 11, the dispenser 270 further includes first 330 and second 334 lateral guide members. The lateral guide members 330, 334 are parallel to one another and located below the angled slots 282 and serve to control lateral movement of bag roll 158 so as to direct the U-shaped cutout 126 in the upper portion 130 of the bags 10 to the separating tongue 298.

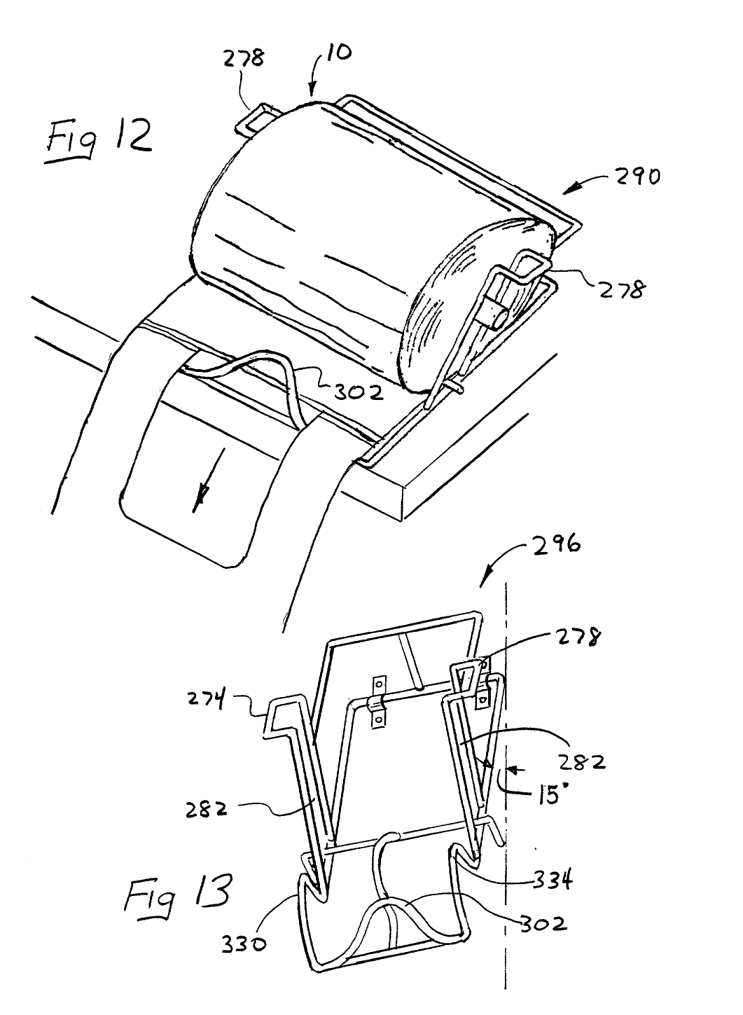

In another variant, illustrated in FIG. 12, the dispenser 290 is mounted at an angle to the horizontal of between zero and eighty-five degrees. In a final variant, illustrated in FIG. 13, the dispenser 296 that is sized and shaped to accommodate produce bags 10 for which the bag 10 is folded inwardly from the first 22 and second 42 linear side edges for a third predetermined dimension 154 prior to rolling, is mounted at an angle to the horizontal of between zero and eighty-five degrees.

The roll mounted plastic produce bag 10 and related dispensers 194, 266, 270, 290, 296 have been described with reference to particular embodiments. Other modifications and enhancements can be made without departing from the spirit and scope of the claims that follow.

1. A roll mounted plastic produce bag, comprising:
a front panel, said front panel having first and second parallel linear side edges, a top edge and a bottom edge;
a rear panel said rear panel having first and second parallel linear side edges, a top edge and a bottom edge;
two front gusset panels of a first predetermined dimension, each front gusset panel having a top edge, a bottom edge, first and second parallel side edges and being joined at said first side edge to one of the linear side edges of the front panel and extending from the top edge of the front panel to the bottom edge thereof;
two rear gusset panels of the first predetermined dimension, each rear gusset panel having a top edge, a bottom edge, first and second parallel side edges and being joined at said first side edge to one of the linear side edges of the rear panel and extending from the top edge of the rear panel to the bottom edge thereof;
each front gusset panel also joined to a respective one of said rear gusset panels at said second side edge;
each of the front and rear gusset panels being folded inwardly relative to the front and the rear panel;
the top edges of the front panel, the rear panel, the front gusset panels and the rear gusset panels terminating in a first perforation line, said first perforation line being perpendicular to the linear side edges of the front and rear panels;
an upper seam, said upper seam connecting the front panel, the rear panel, the front gusset panels and the rear gusset panels at a level spaced downwardly from and parallel to said first perforation line;
the bottom edges of the front panel, the rear panel, the front gusset panels and the rear gusset panels terminating in a second perforation line, said second perforation line being perpendicular to the linear side edges of the front and rear panels;
a lower seam, said lower seam connecting the front panel, the rear panel, the front gusset panels and the rear gusset panels at a level spaced upwardly from and parallel to said second perforation line;
a U-shaped cutout, said U-shaped cutout being disposed in an upper portion of the bag and commencing at a first point along the first perforation line spaced inwardly from said first linear side edge and extending to a second point along the first perforation line spaced inwardly from said second linear side edge, said cutout extending downwardly toward the lower seam, thereby forming an open mouth and a pair of bag handles;
said second perforation line attaching the bag to a subsequent bag; and
said bags being rolled from their upper seams toward their lower seams onto a core to form a compact roll from which the bags are dispensed.

2. A roll mounted plastic produce bag as described in claim 1, wherein the bag is folded inwardly from the first and second linear side edges for a third predetermined dimension prior to rolling the bags onto a cylindrical core, thereby providing a more compact roll of bags.

3. Method for forming a roll mounted plastic produce bag, comprising:
extruding a continuous tube of plastic film material, said tube having first and second parallel sides;
folding said tube inwardly at said first and second side for a first predetermined distance to form a pair of gussets;
flattening said tube to form a front panel and a rear panel, each of said panels having a first linear side edge and a second linear side edge;
perforating said tube perpendicular to said first and second linear side edges to form a first perforation line;
sealing said tube at a level spaced downwardly from and parallel to said first perforation line to form an upper seam;
sealing said tube at a level spaced downwardly from and parallel to said upper seam to form a lower seam;
perforating said tube at a level spaced downwardly from and parallel to said lower seam to form a second perforation line;
cutting a U-shaped cutout in an upper portion of the bag, said U-shaped cutout commencing at a first point along the first perforation line spaced inwardly from said first linear side edge and extending to a second point along the first perforation line spaced inwardly from said second linear side edge, said cutout extending downwardly toward the lower seam, thereby forming an openable mouth and a pair of bag handles; and
rolling the bags joined at the perforation lines onto a cylindrical core to form a roll.

4. Method for forming a roll mounted plastic produce bag, as described in claim 4, further comprising:
folding the bag inwardly from the first and second linear side edges for a third predetermined dimension prior to rolling the bags onto the cylindrical core, thereby providing a more compact roll of bags.

5. A dispenser for roll mounted plastic produce bags as described in claim 1, comprising:
a backing plate, said backing plate having a top edge, a bottom edge, first and second side edges, a front surface and a back surface;
first and second spindles, each of said spindles having a side member and a mounting member;
said side members having a first end and a second end and being hingedly mounted at their first ends to said backing plate, said side members being mounted parallel to each other;
said mounting members having a first end and a second end and being fixedly attached at their first ends to the second ends of the side members;
a separating tongue, said tongue having a first end and a second end and being fixedly mounted at its first end to the front surface of the backing plate, the second end of the tongue extending outwardly from said backing plate; and
whereby, when a roll of plastic produce bags is mounted between the spindles with mounting members supporting a cylindrical core of the roll, the roll will be free to rotate and the separating tongue will extend upwardly through the U-shaped cutout in a bag, the tongue serving to restrict movement of a subsequent bag when a bag is pulled from the roll by bearing against the lower seam of the subsequent bag, thereby permitting the bag to be torn from the roll.

6. A dispenser for roll mounted plastic produce bags as described in claim 5 wherein the dispenser is sized and shaped to accommodate produce bags as described in claim 2.

7. A dispenser for roll mounted plastic produce bags as described in claim 1, comprising:
first and second core supporting elements, said core supporting elements having parallel, upwardly angled slots, said slots being sized, shaped and disposed to slidably constrain first and second ends of a cylindrical produce bag core on which said bags are wound in a roll;
said angled slots permitting said bag core to slide downwardly within said slots as the number of bags wound onto said core diminishes;
a separating tongue, said separating tongue being centrally disposed between said angled slots, and being sized and shaped to locate the U-shaped cutout in the upper portion of the bags as bags are pulled from the roll;
a breaker member, said breaker member being centrally disposed between and below said angled slots, and being sized and shaped to engage the U-shaped cutout in the upper portion of the bags as bags are pulled from the roll and providing a means to constrain the removal of bags from the roll so that the perforation lines joining a bag to a subsequent bag will be torn as the bag is pulled from the roll; and
means for securing the dispenser to either of a vertical surface and a horizontal surface.

8. A dispenser for roll mounted plastic produce bags as described in claim 7, wherein the dispenser is sized and shaped to accommodate produce bags as described in claim 2.

9. A dispenser for roll mounted plastic produce bags as described in claim 7, further comprising first and second lateral guide members, said lateral guide members being parallel to one another and disposed below said angled slots and serving to control lateral movement of bag roll so as to direct the U-shaped cutout in the upper portion of the bags to the separating tongue.

10. A dispenser for roll mounted plastic produce bags as described in claim 9, wherein the dispenser is sized and shaped to accommodate produce bags as described in claim 2.

11. A dispenser for roll mounted plastic produce bags as described in claim 7, wherein the dispenser is mounted at an angle to the horizontal of between zero and eighty-five degrees.

12. A dispenser for roll mounted plastic produce bags as described in claim 10, wherein the dispenser is mounted at an angle to the horizontal of between zero and eighty-five degrees.
